(19) United States
(12) Patent Application Publication
(10) Pub. No.: US 2025/0149602 A1
(43) Pub. Date: May 8, 2025

(54) A SOLID OXIDE CELL STACK SYSTEM COMPRISING A MULTI-STREAM SOLID OXIDE CELL STACK HEAT EXCHANGER

(71) Applicant: Topsoe A/S, Kgs. Lyngby (DK)

(72) Inventor: Dennis Rasmussen, Kgs. Lyngby (DK)

(73) Assignee: Topsoe A/S, Kgs. Lyngby (DK)

(21) Appl. No.: 18/835,337

(22) PCT Filed: Feb. 9, 2023
(86) PCT No.: PCT/EP2023/053167

§ 371 Date: Aug. 1, 2024

(30) Foreign Application Priority Data
Feb. 17, 2022 (EP) 22157260.5

(51) Int. Cl. H01M 8/04007; C25B 9/77; C25B 13/05; C25B 15/021; C25B 15/08; H01M 8/04082; H01M 8/12

(52) U.S. Cl. CPC H01M 8/04067; C25B 9/77; C25B 13/05; C25B 15/021; C25B 15/08; H01M 8/04201; H01M 2008/1293

(57) ABSTRACT

A SOC stack system comprises one or more solid oxide cell stacks and multi-stream solid oxide cell stack heat exchanger(s).

### FIELD OF THE INVENTION

The invention relates to a Solid Oxide Cell (SOC) stack system, comprising one or more SOC stacks and a multistream SOC stack heat exchanger.

### BACKGROUND OF THE INVENTION

In SOC stacks which have an operating temperature between 600° C. and 1000° C., preferably between 600° C. and 850° C., several cell units are assembled to form the stack and are linked together by interconnects. Interconnects serve as a gas barrier to separate the anode and cathode sides of adjacent cell units, and at the same time they enable current conduction between the adjacent cells, i.e. between an anode of one cell and a cathode of a neighbouring cell. Further, interconnects are normally provided with a plurality of flow paths for the passage of process gas on both sides of the interconnect. To optimize the performance of a SOC stack, a range of positive values should be maximized without unacceptable consequence on another range of related negative values which should be minimized. Some of these values are:

| VALUES TO BE MAXIMIZED | VALUES TO BE MINIMIZED |
|---|---|
| Process gas utilization | Cost |
| Electrical efficiency | Dimensions |
| Lifetime | Production time |
| | Fail rate |
| | Number of components |
| | Material use |
| | Parasitic loss (heating, |
| | cooling, blowers . . . ) |

Almost all the above listed values are interrelated, which means that altering one value will impact other values. Some relations between the characteristics of process gas flow in the cells and the above values are mentioned here:

### Process Gas Utilization:

The flow paths on the interconnect should be designed to seek an equal amount of process gas to each cell in a stack, i.e. there should be no flow—“short-cuts” through the stack.

### Parasitic Loss:

Design of the process gas flow paths in the SOC stack and its cell units should seek to achieve a low pressure loss per flow volume, which will reduce the parasitic loss to blowers.

### Electric Efficiency:

The interconnect leads current between the anode and the cathode layer of neighbouring cells. Hence, to reduce internal resistance, the electrically conducting contact points (hereafter merely called “contact points”) of the interconnect should be designed to establish good electrical contact to the electrodes (anode and cathode) and the contact points should no where be far apart, which would force the current to run through a longer distance of the electrode with resulting higher internal resistance.

### Lifetime:

It is desirable that the lifetime of an SOC stack is maximized, i.e. that in SOEC mode the amount of electrolysis product (e.g. H₂ and/or CO) is maximized. Stack lifetime depends on a number of factors, including the choice of the interconnect and spacer, on flow distribution on both process gas sides of the interconnect, evenly distributed protective coating on the materials, on the operating conditions (temperature, current density, voltage, etc), on cell design and materials and many other factors.

### Cost:

The cost of the SOC stack can be reduced by not using noble materials, by reducing the production time of the stack components, minimizing the number of components and by minimizing the material loss (the amount of material discarded during the production process).

### Dimensions:

The overall dimensions of a cell stack are reduced, when the interconnect design ensures a high utilization of the active cell area. Dead-areas with low process gas flow should be reduced and inactive zones for sealing surfaces should be minimized.

### Production Time.

Production time of the stack components should be minimized, and the design of the stack and its components should also contribute to a fast assembling of the stack. In general, for every component the stack design renders unnecessary, there is a gain in production time.

### Fail Rate.

The stack components production methods and materials should permit a low fail rate (such as unwanted holes in the interconnect gas barrier, uneven material thickness or characteristics). Further the fail-rate of the assembled cell stack can be reduced when the interconnect design reduces the total number of components to be assembled and reduces the length and number of seal surfaces.

### Number of Components.

Apart from minimizing errors and assembling time as already mentioned, a reduction of the number of components leads to a reduced cost.

The way the anode and cathode gas flows are distributed in a SOC stack is by having a common manifold for each of the two process gasses, the oxy and fuel gas. The manifolds can either be internal or external. The manifolds supply process gasses to the individual layers in the SOC stack by the means of channels to each layer. The channels are normally situated in one layer of the repeating elements which are comprised in the SOC stack, i.e. in the spacers or in the interconnect. Internal gas manifolds are often in the form of apertures in the cell and/or interconnect components which form one or a number of channels and gas in/outlets when the cell components are stacked. External manifolds on the other hand are often formed as covers which may cover for instance one or more sides of the SOC stack and thereby distribute the process gas to the side of the stack and thus the edge of each cell in the stack. Instead of a cover the stack may also simply be arranged in a container where the process gas flows and thus the process gas has access to the sides of the stack from where the process gas may flow into the stack from the open edge zones of each cell.

In the following, the system will be explained in relation to Solid Oxide Electrolysis Cells (SOEC). It is to be understood however that the system may also be utilized for Solid Oxide Fuel cells (SOFC). High temperature electrolysis (SOEC) is an endothermic electrochemical conversion of H2O to H2 or CO2 to CO on the fuel side of the cell. The endothermic electrochemical process is counteracted by the heat generated inside the SOEC stack from ohmic losses (Joule heating), which is proportional with the current through the stack. When the endothermic process is balanced with the ohmic losses, the stack can be operated “thermoneutrally”, i.e. the temperature profile from fuel inlet to outlet is ideally constant. But in many operating points, especially at part load, the heat generated by the ohmic losses is less than the heat consumed for the electrochemical process—this creates a thermal profile across the cells, where the temperature drops from inlet to outlet.

The local current density (i) in a given area of the cell is controlled by the Nernst potential, which is affected by the local temperature and gas compositions. The local gas composition is controlled by stack design, e.g. the choice of flow paths, where the goal is to get as even distribution of gas across the cell, between the cells in a stack and between stacks—all while simultaneously minimizing the pressure drop. But even with perfect flow distribution, the fuel concentration will always be higher at fuel inlet (and product concentration low), which favors a higher than average current density. When the stack is run at an operating point (current) below the thermoneutral point, the temperature at fuel inlet is higher than the rest of the cell—further increasing the local current density. Thus, in most operating points, the maximum current density (imax) is located at the fuel inlet area.

Several degradation mechanisms are highly affected by the current density, and even accelerated if the current density is higher than a certain “threshold value”. For example, Chen et al. (Journal of The Electrochemical Society, 160 (8) F883-F891 (2013)) demonstrate that additional degradation mechanisms, such as the formation of ZrO2 nanoparticles, can be observed in SOECs operated at high current densities (at 1 A/cm2 or 1.5 A/cm2 in electrolysis mode), while the same degradation mechanisms were not present in tests running at 0.75 A/cm2 or 0.5 A/cm2 in electrolysis mode. In another example (Knibbe et al, Journal of The Electrochemical Society, 157 (8) B1209-B1217 (2010)), increased degradation of ohmic resistance was observed due to oxygen bubble formation and delamination at the oxygen electrode/electrolyte interface, when the electrolysis current was increased from 1 A/cm2 to 1.5 A/cm2 to 2 A/cm2. Mogensen et al have reported that operation at high current densities (high electrode overpotentials) can lead to the loss of Ni from the electrochemically active fuel electrode/electrolyte interface in SOECs based on Ni/YSZ electrodes (Fuel Cells, 17, 2017, No. 4, 434-441). In SOFC mode, Hagen et al. (Journal of The Electrochemical Society, 153 (6) A1165-A1171 (2006)) have demonstrated that the degradation rate increased as a function of cell polarization (current density) at all operating temperatures tested (750° C., 850° C. and 950° C.). The degradation rate at a fixed current density increased more steeply at 750° C. than at 850° C. (and 950° C.), suggesting that the degradation phenomena is related to electrode overpotential.

Keeping the maximum current density (imax) as low as possible, while maintaining high production rate (iavg) is thus highly desirable to minimize stack degradation and loss of system efficiency. In other words, it is desirable to obtain even current density profile across the stack, and especially a low imax while maintaining a fixed iavg.

As production rate from a stack is linked to the active area (the area where the electrochemical processes occur), it is desirable to maximize the active area. The active area of a stack is naturally linked to the size of the cells, but the active area of the cell is reduced by sealing area and area used for manifolding. It is thus desirable to maximize the active area of the cell, by reducing the area used for sealing and manifolding.

In SOEC mode, the product is the converted gas—and the quality of the converted gas, also called the product gas is critical for downstream applications. It is thus desirable to minimize leaks of undesired components (e.g. air) into the product to obtain a high purity.

As the SOEC process operates at high temperature levels and comprises two fluid sides, the process side fluid and the oxy side fluid, the cold feeds, process and oxy, must be heated to the SOEC temperature. The primary heating takes place by heat exchange with the hot SOEC fluids. Balance heat is added by for instance one or more electric heaters.

Adding heat exchangers to the SOE stack system poses a problem with relation to cost, fail rate, number of components, dimensions, production time etc. as also discussed earlier.

US2021098796 discloses a modular pressurized hotbox for use and substitution in a variety of pressurized electrochemical applications to include reversible solid oxide electrolyzer and fuel cells, energy storage systems, renewable fuel production, solid-state hydrogen pumping and liquefaction, and oxygen transport membranes. This is enabled by mixed electronic and ionic conducting compositions of vanadia-yttria and vanadia-calcia stabilized zirconia and a dry powder method of manufacture for ceramic core stacks.

US2021156039 describes a modular system for hydrogen generation includes a plurality of cores and a hub. Each core includes an electrolyzer and a power supply. The power supply is operable to manage electrical power to the electrolyzer of the core and is redundant to the power supply of at least another one of the plurality of cores. The hub includes a water module, a heat exchange module, and a switchgear module. The water module includes a water source in fluid communication with the electrolyzer of each one of the plurality of cores, the heat exchange module includes a heat exchanger in thermal communication with the electrolyzer of each one of the plurality of cores, and the switchgear module includes a switch activatable to electrically isolate the power supply of each one of the plurality of cores.

WO15169940 discloses a core unit in the shape of an integrated module for fuel cell based power generation consists of an inlet or more inlets for fuel cell suitable fuels, said fuels comprising hydrogen, hydrocarbon-based fuels, steam reformed fuels (such as hydrocarbons, alcohols and ethers) and ammonia, one or more inlets for air, one or more off-gas outlets, heat exchangers, and a fuel cell assembly, all mounted in an insulated housing or in several separate insulated housings connected by relevant piping. The unit is an SOFC sub-system, preferably in the 1.5 kW (DC) power range, designed to provide a simple interface to natural gas based SOFC technology. The system features tight integration of the SOFC stack(s) or stack module(s) and all hot balance of plant components. Since the system is designed for anode off-gas recycling, the unit requires no external water supply once in operation. Anode gas recycling results in high overall fuel utilization and in high electrical efficiency.

WO20165548 discloses an electrolytic cell for an electrolytic treatment of a liquid, the electrolytic cell comprising a receptacle defining an electrolysis chamber; a first set of conductive plates, a second set of conductive plates, and a third set of conductive plates, which are arranged in the electrolysis chamber, the conductive plates of the first, second and third sets extending radially in relation to the longitudinal axis of the receptacle; an electrical power source configured to supply electricity to the conductive plates of the first, second and third sets; a switching device configured to interrupt the electricity supply to the conductive plates of the first, second and third sets and to modify the electrical connection between the conductive plates of the first, second and third sets and positive and negative terminals of the electrical power source; and a control unit configured to control the switching device according to an operating cycle.

None of the above described known art documents provides a solution to the above described problems which are solved by the present invention.

Therefore, with reference to the above listed considerations, there is a need for a SOC stack system comprising an improved efficient heat exchange solution to reduce some of the above described problems.

These and other objects are achieved by the invention as described below.

### SUMMARY OF THE INVENTION

According to the invention, a solid oxide cell stack system is provided, which comprises one or more solid oxide cell stacks. Each of the SOC stacks comprises a process fluid side and an oxy fluid side as also mentioned earlier. The process fluid side comprises at least one stack process fluid inlet and at least one stack process fluid outlet, to be able to provide process fluid to the stack and to lead away process fluid from the SOC stack. The oxy fluid side likewise comprises at least one stack oxy fluid inlet and at least one stack oxy fluid outlet, also to enable oxy fluid to be provided and lead away from the the SOC stack.

Furthermore, the SOC stack system comprises a multi-stream SOC stack heat exchanger. According to the invention the process and oxy side fluids are heated up, and cooled down in a single multi-stream SOC heat exchanger, which is advantageous relative to having a separate heat exchanger for the process fluid side and a separate heat exchanger for the oxy fluid side of the SOC stack. In the multi-stream SOC stack heat exchanger, the cold and hot sides of the two fluids (process- and oxy-) are exchanging heat alternately in separate passes of the multi-stream SOC stack heat exchanger. This ensures uniform heating of both the process and the oxy side of the fluids and obviously allows the use of a single heater to maintain the SOC stack temperature. Hence, according to the invention, not only is the number of components (and all the following advantages this involves as discussed before) reduced with regard to the necessary heat exchanging, but also with regard to the necessary heating by use of only one single heater. Even further, this also reduces the requirement of instrumentation to control and maintain uniform heating of the two sides (process and oxy) and to protect against high temperature difference.

The multi-stream SOC stack heat exchanger comprises at least eight fluid connections: at least four inlets and at least four outlets. The process side and the oxy side are exchanging heat alternately, i.e. two passes exchanges heat between cold/hot process sides, followed by two passes exchanging heat between cold/hot oxy sides. In more detail, the at least eight fluid connections comprises: a first heat exchanger process fluid inlet, upstream in fluid connection with a process fluid supply; a second heat exchanger process fluid inlet, upstream in fluid connection with the stack process fluid outlet; a first heat exchanger process fluid outlet, upstream in fluid connection with the first heat exchanger process fluid inlet, downstream in fluid connection with the stack process fluid inlet; a second heat exchanger process fluid outlet, upstream in fluid connection with the second heat exchanger process fluid inlet, downstream in fluid connection with a process fluid exhaust; a first heat exchanger oxy fluid inlet, upstream in fluid connection with an oxy fluid supply; a second heat exchanger oxy fluid inlet, upstream in fluid connection with the stack oxy fluid outlet; a first heat exchanger oxy fluid outlet, upstream in fluid connection with the first heat exchanger oxy fluid inlet, downstream in fluid connection with the stack oxy fluid inlet; a second heat exchanger oxy fluid outlet, upstream in fluid connection with the second heat exchanger oxy fluid inlet, downstream in fluid connection with an oxy fluid exhaust.

In an embodiment of the invention, the one or more SOC stacks are SOEC stacks. As discussed in the above, the present invention is applicable both for SOC stacks which run in electrolysis mode as well as in fuel mode, since both these applications may require heat exchange. Also, in an embodiment of the invention, the SOC stack system comprises both SOEC and SOFC stacks. In a further embodiment, the SOEC stacks according to the invention has a cell area of between 20000 MM² and 160000 MM² pr. Cell (on one side of the cell).

In an embodiment of the invention the multi stream SOC stack heat exchanger is a plate heat exchanger. This embodiment is also the embodiment shown in the drawings where it will be explained in more detail. In an embodiment of this invention, a relative cold process fluid pass of the SOC stack heat exchanger exchanges heat with a relative hot process fluid pass of the multi-stream SOC stack heat exchanger. But furthermore, a relative cold oxy fluid pass of the multi-stream SOC stack heat exchanger exchanges heat with a relative hot oxy fluid pass of the multi-stream SOC stack heat exchanger; and even furthermore, a process fluid side and an oxy fluid side of the multi-stream SOC stack heat exchanger exchanges heat alternately. Hence, as is one of the advantages of this invention, not only the process hot/cold streams exchanges heat, also the oxy hot/cold streams exchanges heat in the same device, the multi stream SOC stack heat exchanger, and even further, also the oxy and the process streams exchanges heat in this same device, in alternate passes, which provides a very even temperature of all the fluid streams, in a compact, efficient device, which is cheaper, has less heat loss and fewer components to mention some of the advantages, when compared with known solutions.

But this is not the only advantage, in an embodiment of the invention the system further comprises at least one heater adapted to heat the process fluid, the oxy fluid or both the process fluid and the oxy fluid. Since the fluid streams all run through the multi-stream SOC stack heat exchanger it may be suficcient with a heater that heats just one of the fluid streams upstream the multi-stream SOC stack heat exchanger, since this fluid stream will then deliver the heat to the rest of the fluid streams when heat exchanging with them all in the multi-stream SOC stack heat exchanger. It is to be understood that there may off course be more heaters or that one heater heats more than one fluid stream, whatever is the most efficient or beneficial, but one of the advantages of this invention is that it provides even heat distribution to all fluid streams and hence to the SOC stack in an efficient, compact and simple manner, which also ensures a more even temperature distribution than is the case with more heat exchangers.

In an embodiment of the invention, the at least one heater may even be integrated within the multi-stream SOC heat exchanger. This may reduce heat loss and physical dimensions of the equipment. In a further embodiment, the heater may be integrated within the one or more SOC stacks, reducing number of components, physical dimensions and heat loss to the surroundings. In an embodiment of the invention the heater may be an electrical heater.

In an embodiment of the invention, the multi-stream SOC heat exchanger comprises at least a further two fluid connections, a heating fluid inlet and a heating fluid outlet. The heater comprises a heating fluid in fluid connection with the multi-stream SOC heat exchanger via the heating fluid inlet and the heating fluid outlet. Hence, the heating fluid is heated in the heater and delivers this heat to the process- and the oxy fluid in the multi-stream SOC heat exchanger when the heating fluid is heat exchanging in the multi-stream SOC heat exchanger.

In a further embodiment of the invention, the multi-stream SOC stack heat exchanger is located within a thermally insulated container which also comprises the one or more SOC stacks, which among other has the advantage that heat loss is reduced. However, in an embodiment of the invention, the multi-stream SOC stack heat exchanger may also be located outside thermally insulated container comprising the one or more SOC stacks, which may be an advantage if the SOC stacks need to be replaced or for other reasons are better insulated without the multi-stream SOC stack heat exchanger.

### FEATURES OF THE INVENTION

1. A Solid oxide cell stack system comprising one or more solid oxide cell stacks, each solid oxide cell stack comprising a process fluid side and an oxy fluid side, the process fluid side comprising at least one stack process fluid inlet and at least one stack process fluid outlet, the oxy fluid side comprising at least one stack oxy fluid inlet and at least one stack oxy fluid outlet, wherein the solid oxide cell stack system further comprises
a multi-stream solid oxide cell stack heat exchanger comprising at least eight fluid connections:
a first heat exchanger process fluid inlet, upstream in fluid connection with a stack process fluid outlet,
a second heat exchanger process fluid inlet, upstream in fluid connection with a a process fluid supply,
a first heat exchanger process fluid outlet, upstream in fluid connection with the first heat exchanger process fluid inlet, downstream in fluid connection with a process fluid exhaust,
a second heat exchanger process fluid outlet, upstream in fluid connection with the second heat exchanger process fluid inlet, downstream in fluid connection with the stack process fluid inlet,
a first heat exchanger oxy fluid inlet, upstream in fluid connection with the stack oxy fluid outlet,
a second heat exchanger oxy fluid inlet, upstream in fluid connection with an oxy fluid supply,
a first heat exchanger oxy fluid outlet, upstream in fluid connection with the first heat exchanger oxy fluid inlet, downstream in fluid connection with an oxy fluid exhaust,
a second heat exchanger oxy fluid outlet, upstream in fluid connection with the second heat exchanger oxy fluid inlet, downstream in fluid connection with the stack oxy fluid inlet.

2. A solid oxide cell stack system according to feature 1, wherein the one or more solid oxide cell stacks are solid oxide electrolysis cell stacks.

3. A solid oxide cell stack system according to feature 2, wherein the solid oxide electrolysis cell stacks each has a cell area of between 20000 MM² and 160000 MM².

4. A solid oxide cell stack system according to feature 1, comprising solid oxide electrolysis cell stacks and solid oxide fuel cell stacks.

5. A solid oxide cell stack system according to any of the preceding features, wherein the multi-stream solid oxide cell stack heat exchanger is a plate heat exchanger.

6. A solid oxide cell stack system according to feature 5, wherein a relative cold process fluid pass of the multistream solid oxide cell stack heat exchanger exchanges heat with a relative hot process fluid pass of the multi-stream solid oxide cell stack heat exchanger; and a relative cold oxy fluid pass of the multi-stream solid oxide cell stack heat exchanger exchanges heat with a relative hot oxy fluid pass of the multi-stream solid oxide cell stack heat exchanger and whereby a process fluid side and an oxy fluid side of said multi-stream solid oxide cell stack heat exchanger exchanges heat alternately.

7. A solid oxide cell stack system according to any of the preceding features, wherein the system further comprises at least one heater adapted to heat the process fluid, the oxy fluid or both the process fluid and the oxy fluid.

8. A solid oxide cell stack system according to feature 7, wherein the heater is integrated within the multi-stream solid oxide cell stack heat exchanger.

9. A solid oxide cell stack system according to feature 7, wherein the heater is integrated within the one or more solid oxide cell stacks.

10. A solid oxide cell stack system according to feature 7, 8 or 9 wherein the heater is an electrical heater.

11. A solid oxide cell stack system according to feature 7 or 8, wherein the multi-stream solid oxide cell stack heat exchanger has further two fluid connections, a heating fluid inlet and a heating fluid outlet, and the heater comprises a heating fluid in fluid connection with the multistream solid oxide cell stack heat exchanger via the heating fluid inlet and the heating fluid outlet.

12. A solid oxide cell stack system according to any of the preceding features, wherein the multi-stream solid oxide cell stack heat exchanger is located within an insulated container further comprising the one or more solid oxide cell stacks.

13. A solid oxide cell stack system according to any of the features 1-12, wherein the multi-stream solid oxide cell stack heat exchanger is located outside an insulated container comprising the one or more solid oxide cell stacks.

### BRIEF DESCRIPTION OF THE DRAWINGS

The invention is further illustrated by the accompanying drawings showing examples of embodiments of the invention. It is to be understood that the invention according to the claims covers other embodiments than the ones shown in the drawings which serve the purpose of explaining the invention with specific examples.

FIG. 1 shows a schematic/principle side-cross-cut view of the multi stream SOC stack heat exchanger, specifically the process fluid side, according to an embodiment of the invention.

FIG. 2 shows a schematic/principle side-cross-cut view of the multi stream SOC stack heat exchanger, specifically the oxy fluid side, according to an embodiment of the invention.

FIG. 3 shows a schematic/principle top-cross-cut view of the multi stream SOC stack heat exchanger, specifically a relative hot fluid side, according to an embodiment of the invention.

FIG. 4 shows a schematic/principle top-cross-cut view of the multi stream SOC stack heat exchanger, specifically a relative cold fluid side, according to an embodiment of the invention.

### POSITION NUMBERS

01. Multi-stream SOC stack heat exchanger.
02. First Multi-stream SOC stack heat exchanger process fluid inlet.
03. Second Multi-stream SOC stack heat exchanger process fluid inlet
04. First Multi-stream SOC stack heat exchanger process fluid outlet
05. Second Multi-stream SOC stack heat exchanger process fluid outlet
06. First Multi-stream SOC stack heat exchanger oxy fluid inlet.
07. Second Multi-stream SOC stack heat exchanger oxy fluid inlet
08. First Multi-stream SOC stack heat exchanger oxy fluid outlet
09. Second Multi-stream SOC stack heat exchanger oxy fluid outlet
10. Multi-stream SOC stack heat exchanger plate layer

### DETAILED DESCRIPTION

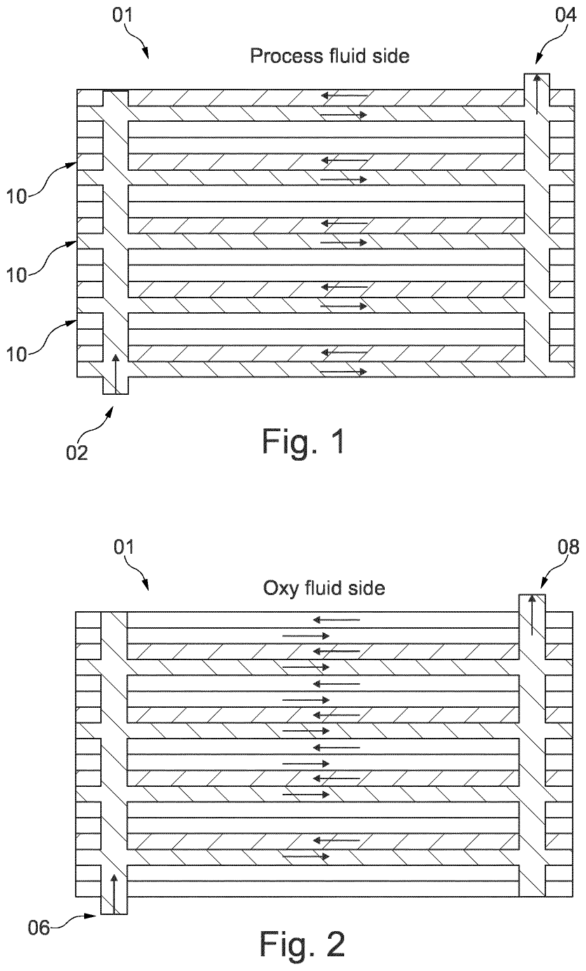

FIG. 1 shows a schematic/principle side-cross-cut view of the multi stream SOC stack heat exchanger 01, specifically the process fluid side, according to an embodiment of the invention. The SOC stack part of the SOC stack system is not shown, but it is to be understood that the SOC stack part is in fluid connection with the multi stream SOC stack heat exchanger part of the system as also explained above and according to the claims. In this embodiment, the multi stream SOC stack heat exchanger is of the plate heat exchanger type, as can be seen in principle, as the multi stream SOC stack heat exchanger comprises 18 individual multi stream SOC stack heat exchanger plate layers 10. To explain the principle step by step more simplified, FIG. 1 focuses on the process fluid side and in particular the relative hot part of the process fluid side of the multi stream SOC stack heat exchanger.

Via a first multi stream SOC stack heat exchanger process fluid inlet 02, a relative hot process fluid flow is led from the SOC stack (not shown) and enters and is distributed to five single plate layers of the multi stream SOC stack heat exchanger; before the now heat exchanged (cooled) process fluid flow exits the multi stream SOC stack heat exchanger via a first multi stream SOC stack heat exchanger process fluid outlet 04. In the multi stream SOC stack heat exchanger, the relative hot process fluid flow is heat exchanged not only with the relative cold process fluid flow, but also with the oxy fluid as will be discussed more with reference to the remaining figures. The heated process fluid exiting the multi stream SOC stack heat exchanger is led further to a process fluid inlet of the SOC stack (not shown)—possibly via one or more heaters. Hence, as can be seen in FIG. 1, the relative hot process fluid flows in only every fourth plate layers of the multi stream SOC stack heat exchanger, as the remaining layers are relative cold process fluid flow, and relative hot and cold oxy fluid flows alternating.

In FIG. 2 a schematic/principle side-cross-cut view of the multi stream SOC stack heat exchanger 01, specifically the oxy fluid side, according to an embodiment of the invention is shown. Corresponding to the process fluid side, the relative hot oxy fluid flow exiting the SOC stack is led from the SOC stack (not shown) and enters via the first multistream SOC stack heat exchanger oxy fluid inlet 06 and is distributed to (in this case) four single plate layers of the multi stream SOC stack heat exchanger; before the now heat exchanged (cooled) process fluid flow exits the multi stream SOC stack heat exchanger via a first multi stream SOC stack heat exchanger oxy fluid outlet 08. In the multi stream SOC stack heat exchanger, the relative hot oxy fluid flow is heat exchanged not only with the relative cold oxy fluid flow, but also with the process fluid. The heated oxy fluid exiting the multi stream SOC stack heat exchanger is led further to an oxy fluid inlet of the SOC stack (not shown)—possibly via one or more heaters. Hence, as can be seen in FIG. 2, the relative hot oxy fluid flows in only every fourth plate layers of the multi stream SOC stack heat exchanger, as the remaining layers are relative cold oxy fluid flow, and relative hot and cold process fluid flows alternating.

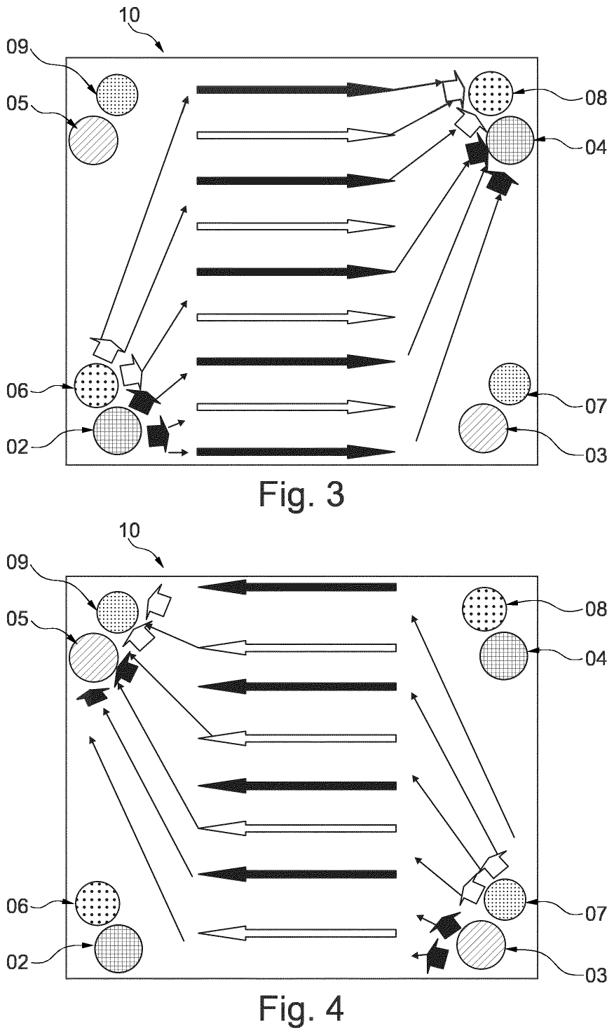

In FIG. 3 and FIG. 4 a schematic/principle top-cross-cut view of the multi stream SOC stack heat exchanger is shown, according to an embodiment of the invention. The inlets and outlets of both the relative cold and relative hot fluid sides are shown, to visualize the eight fluid connections. In FIG. 3, the focus is on the relative hot fluid flows, which enter the multi stream SOC stack heat exchanger via the first multi stream SOC stack heat exchanger -process fluid inlet 02 and -oxy fluid inlet 06. These relative hot fluids pass over each of their separate plate layers, which can not all be seen in this top view, butare here schematically shown as fat filled arrows relating to the process fluid and not-filled arrows relating to the oxy fluid. After passing the plate layers, the now heat exchanged/cooled process- and oxy fluid flows exit via the first multi-stream SOC stack heat exchanger process- and oxy fluid outlets 04 and 08.

Accordingly, in FIG. 4, focuses on the relative cold fluid flows, which enter the multi stream SOC stack heat exchanger via the second multi stream SOC stack heat exchanger—process fluid inlet 03 and -oxy fluid inlet 07. These relative hot fluids pass over each of their separate plate layers, and are here again schematically shown as fat filled arrows relating to the process fluid and not-filled arrows relating to the oxy fluid. After passing the plate layers, the now heat exchanged/heated process—and oxy fluid flows exit via the second multi-stream SOC stack heat exchanger process fluid outlet 05 and 08 and the second multi-stream SOC stack heat exchanger oxy fluid outlet 09.

1. A Solid oxide cell stack system comprising one or more solid oxide cell stacks, each solid oxide cell stack comprising a process fluid side and an oxy fluid side, the process fluid side comprising at least one stack process fluid inlet and at least one stack process fluid outlet, the oxy fluid side comprising at least one stack oxy fluid inlet and at least one stack oxy fluid outlet, wherein the solid oxide cell stack system further comprises
a multi-stream solid oxide cell stack heat exchanger comprising at least eight fluid connections:
a first heat exchanger process fluid inlet, upstream in fluid connection with a stack process fluid outlet,
a second heat exchanger process fluid inlet, upstream in fluid connection with a process fluid supply,
a first heat exchanger process fluid outlet, upstream in fluid connection with the first heat exchanger process fluid inlet, downstream in fluid connection with a process fluid exhaust,
a second heat exchanger process fluid outlet, upstream in fluid connection with the second heat exchanger process fluid inlet, downstream in fluid connection with the stack process fluid inlet,
a first heat exchanger oxy fluid inlet, upstream in fluid connection with the stack oxy fluid outlet,
a second heat exchanger oxy fluid inlet, upstream in fluid connection with an oxy fluid supply,
a first heat exchanger oxy fluid outlet, upstream in fluid connection with the first heat exchanger oxy fluid inlet, downstream in fluid connection with an oxy fluid exhaust,
a second heat exchanger oxy fluid outlet, upstream in fluid connection with the second heat exchanger oxy fluid inlet, downstream in fluid connection with the stack oxy fluid inlet.

2. A solid oxide cell stack system according to claim 1, wherein the one or more solid oxide cell stacks are solid oxide electrolysis cell stacks.

3. A solid oxide cell stack system according to claim 2, wherein the solid oxide electrolysis cell stacks each has a cell area of between 20000 MM² and 160000 MM².

4. A solid oxide cell stack system according to claim 1, comprising solid oxide electrolysis cell stacks and solid oxide fuel cell stacks.

5. A solid oxide cell stack system according to claim 1, wherein the multi-stream solid oxide cell stack heat exchanger is a plate heat exchanger.

6. A solid oxide cell stack system according to claim 5, wherein a relative cold process fluid pass of the multi-stream solid oxide cell stack heat exchanger exchanges heat with a relative hot process fluid pass of the multi-stream solid oxide cell stack heat exchanger; and a relative cold oxy fluid pass of the multi-stream solid oxide cell stack heat exchanger exchanges heat with a relative hot oxy fluid pass of the multi-stream solid oxide cell stack heat exchanger and whereby a process fluid side and an oxy fluid side of said multi-stream solid oxide cell stack heat exchanger exchanges heat alternately.

7. A solid oxide cell stack system according to claim 1, wherein the system further comprises at least one heater adapted to heat the process fluid, the oxy fluid or both the process fluid and the oxy fluid.

8. A solid oxide cell stack system according to claim 7, wherein the heater is integrated within the multi-stream solid oxide cell stack heat exchanger.

9. A solid oxide cell stack system according to claim 7, wherein the heater is integrated within the one or more solid oxide cell stacks.

10. A solid oxide cell stack system according to claim 7, wherein the heater is an electrical heater.

11. A solid oxide cell stack system according to claim 7, wherein the multi-stream solid oxide cell stack heat exchanger has further two fluid connections, a heating fluid inlet and a heating fluid outlet, and the heater comprises a heating fluid in fluid connection with the multi-stream solid oxide cell stack heat exchanger via the heating fluid inlet and the heating fluid outlet.

12. A solid oxide cell stack system according to claim 1, wherein the multi-stream solid oxide cell stack heat exchanger is located within an insulated container further comprising the one or more solid oxide cell stacks.

13. A solid oxide cell stack system according to claim 1, wherein the multi-stream solid oxide cell stack heat exchanger is located outside an insulated container comprising the one or more solid oxide cell stacks.
